(19) United States
(12) Patent Application Publication
(10) Pub. No.: US 2022/0093132 A1
(43) Pub. Date: Mar. 24, 2022

(54) METHOD FOR ACQUIRING VIDEO AND ELECTRONIC DEVICE

(71) Applicant: BEIJING DAJIA INTERNET INFORMATION TECHNOLOGY CO., LTD., Beijing (CN)

(72) Inventor: Zi GE, Beijing (CN)

(21) Appl. No.: 17/483,006

(22) Filed: Sep. 23, 2021

(30) Foreign Application Priority Data
Sep. 24, 2020 (CN) 202011016715.8

(51) Int. Cl. G11B 27/031; G06F 3/16; G10L 13/02; G10L 15/26; G10L 25/57

(52) U.S. Cl. CPC G11B 27/031; G06F 3/165; G10L 25/57; G10L 15/26; G10L 13/02

(57) ABSTRACT

A method for acquiring a video is provided. In the method, a video editing interface is displayed, wherein the video editing interface displays a background image; background music is played; target audio is acquired in response to a first target operation for the video editing interface; and a target video is acquired based on the target audio, the background image, and the background music.

This application is based on and claims priority to Chinese Patent Application No. 202011016715.8, filed on Sep. 24, 2020, the disclosure of which is herein incorporated by reference in its entirety.

### TECHNICAL FIELD

The present disclosure relates to the field of computer technologies, and in particular to a method for acquiring a video and an electronic device.

### BACKGROUND

With the development of computer technologies and diversification of functions of electronic devices, users are capable of doing more and more things with the electronic devices. In their daily lives, users can record videos by the electronic devices, and share and express their emotions over the videos. For example, a video can be acquired by shooting objects or people using the electronic device, and the shot video is uploaded to a social networking platform.

### SUMMARY

Embodiments of the present disclosure provide a method for acquiring a video and an electronic device.

According to one aspect of the embodiments of the present disclosure, a method for acquiring a video is provided. The method includes: displaying a video editing interface, wherein the video editing interface displays a background image; playing background music; acquiring target audio in response to a first target operation for the video editing interface; and acquiring a target video based on the target audio, the background image, and the background music.

According to another aspect of the embodiments of the present disclosure, an electronic device is provided. The electronic device includes: a processor; and a memory configured to store one or more instructions executable by the processor; wherein the processor, when loading and executing the one or more instructions, is caused to: display a video editing interface, wherein the video editing interface displays a background image; play background music; acquire target audio in response to a first target operation for the video editing interface; and acquire a target video based on the target audio, the background image, and the background music.

According to still another aspect of the embodiments of the present disclosure, a non-transitory storage medium storing one or more instructions is provided. The one or more instructions, when loaded and executed by a processor of an electronic device, cause the electronic device to: display a video editing interface, wherein the video editing interface displays a background image; play background music; acquire target audio in response to a first target operation for the video editing interface; and acquire a target video based on the target audio, the background image, and the background music.

### BRIEF DESCRIPTION OF THE DRAWINGS

FIG. 1 is a schematic flowchart of a method for acquiring a video according to an embodiment of the present disclosure;

FIG. 2 is a schematic diagram of an example of a method for acquiring a video according to an embodiment of the present disclosure;

FIG. 3 is a schematic diagram of an example of a method for acquiring a video according to an embodiment of the present disclosure;

FIG. 4 is a schematic diagram of an example of a method for acquiring a video according to an embodiment of the present disclosure;

FIG. 5 is a schematic diagram of an example of a method for acquiring a video according to an embodiment of the present disclosure;

FIG. 6 is a schematic block diagram of an apparatus for acquiring a video according to an embodiment of the present disclosure; and

FIG. 7 is a schematic block diagram of an electronic device according to an embodiment of the present disclosure.

### DETAILED DESCRIPTION

In order to enable those skilled in the art to better understand the technical solutions of the present disclosure, the technical solutions of the embodiments of the present disclosure will be described clearly and completely below in combination with the accompanying drawings.

It should be noted that the terms “first,” “second,” and the like used in the description, claims of the present disclosure, and the drawings are used to distinguish similar objects, and not used to describe any specific order or sequence. It should be understood that the data used in this way may be interchanged under an appropriate condition, such that the embodiments of the present disclosure described herein may be implemented in orders besides those shown in the drawings or described in the present disclosure.

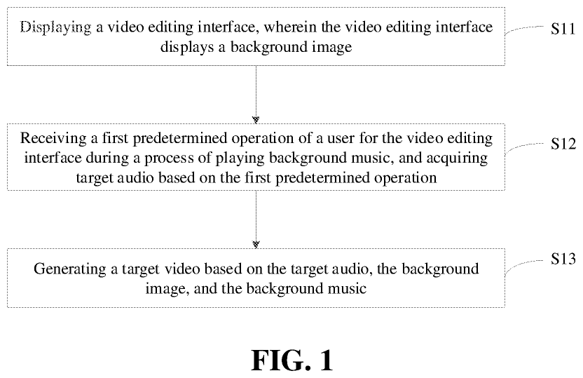

FIG. 1 is a flowchart of a method for acquiring a video according to an embodiment of the present disclosure. The method is applicable to an electronic device. By taking a scenario where the electronic device is a terminal as an example, this embodiment includes the following content.

In S11, a terminal displays a video editing interface, wherein the video editing interface displays a background image.

In some embodiments, various video topic types may be defined in advance, such as birthday, wedding, anniversary, love, family affection, or relaxing. For each topic type, a plurality of corresponding templates may be defined in advance. For each template, a corresponding background image, background music, and a character display effect may be defined in advance. Thus, a user who needs to make a video may select a favorite template from corresponding topic types. In a case that a template is selected, a video editing interface corresponding to the template may be triggered for display.

In some embodiments, one or more background images are defined, which is not limited in the embodiments of the present disclosure. In a case that a plurality of background images are defined, the plurality of background images may be cyclically switched for display on the video editing interface. For example, assuming that there are three background images, namely A, B, and C, the video editing interface may display A first, then B, then C, then A, then B, then C, and then A, . . . , and the like, to cyclically display the three background images of A, B, and C. In a case that a plurality of background images are defined, each of the plurality of background images may be a part of or all of images in a graphics interchange format (GIF) animation, or may be a part of or all of images in a video or video segment.

In S12, the terminal receives a first predetermined operation of a user for the video editing interface during a process of playing background music, and acquires target audio based on the first predetermined operation.

The first predetermined operation is a first target operation.

Specifically, in S12, the terminal plays the background music and acquires the target audio in response to the first target operation for the video editing interface.

In some embodiments, the background music may be background music corresponding to the video editing interface. The background music may include songs, light music, a sound of wind, rain, ocean waves, or the like, which is not specifically limited in the embodiments of the present disclosure.

In some embodiments, the first predetermined operation, i.e., the first target operation, includes one or more sub-operations. The sub-operations include, but are not limited to, various touch operations such as a tap operation (a single-tap operation or a double-tap operation), a swipe operation or a long-press operation. In some embodiments, an action object of the first predetermined operation, i.e., the first target operation, is a function control in the video editing interface, e.g., the target audio is acquired by tapping the function control; or, the action object is a blank position in the video editing interface, e.g., the target audio is acquired by tapping the blank position: or, the action object is a position where the background image is displayed, e.g., the target audio is acquired by tapping the background image; or, the action object is other positions, e.g., the target audio is acquired by tapping and long-pressing the upper left corner of the video editing interface, which is not specifically limited in the embodiments of the present disclosure.

In some embodiments, the first predetermined operation, i.e., the first target operation, is a predetermined record operation for recording audio input by the user, or a predetermined character input operation for acquiring character information input by the user. In response to the first predetermined operation being the predetermined record operation, the target audio is acquired by recording the audio input by the user, and in response to the first predetermined operation being the predetermined character input operation, the target audio is acquired by converting the character information (e.g., characters) input by the user into audio.

In S13, the terminal generates a target video based on the target audio, the background image, and the background music.

Specifically, S13 includes: acquiring, by the terminal, the target video based on the target audio, the background image, and the background music. In some embodiments, the target video is composited locally by the terminal. In some embodiments, the target video is composited by a server at a distal end and then issued to the terminal. For example, the terminal packages the target audio, the background image, and the background music into a video composition request, and sends the video composition request to the server, the server is triggered to composite the target video based on the video composition request, after that, the server issues the target video to the terminal, and the terminal receives the target video returned by the server.

In some embodiments, the target video, generated based on the target audio, the background image, and the background music, includes the target audio, the background image, and the background music. Thus, in response to the user opening the target video, the background image is displayed, and the background music and the target audio are played at the same time.

In some embodiments, in S12, the terminal plays the background music, and the terminal may detect the first predetermined operation, i.e., the first target operation, of the user for the video editing interface during the process of playing the background music, such that the target audio may be acquired in response to the first predetermined operation, i.e., the first target operation, of the user for the video editing interface, and the target video is generated based on the target audio, the background image displayed in the video editing interface, and the background music. Therefore, the terminal is enabled to generate a video only by acquiring the target audio based on the first predetermined operation of the user, i.e., the first target operation. In this way, the user may make videos meeting his/her individual requirements without shooting objects or persons, such that it is more convenient to generate videos.

In some embodiments, prior to S11, the method further includes: displaying thumbnails of N different predetermined templates, wherein N is a positive integer.

S11 includes: displaying a video editing interface corresponding to a target template based on a tenth predetermined operation of the user for a thumbnail of the target template among the N predetermined templates. That is, the terminal displays the video editing interface corresponding to the target template in response to a selection operation of the user for the thumbnail of the target template among the N predetermined templates.

In some embodiments, each of the N predetermined templates includes a corresponding background image and background music. For example, different predetermined templates may correspond to different background images, or different predetermined templates may correspond to different background music, or different predetermined templates may correspond to not only different background images but also different background music.

In some embodiments, the tenth predetermined operation includes, but is not limited to, touch operations such as a tap operation (a single-tap operation or a double-tap operation), a swipe operation, or a long-press operation.

The thumbnails of the N different predetermined templates are displayed, and the video editing interface corresponding to the target template is displayed based on the tenth predetermined operation of the user for the thumbnail of the target template among the N predetermined templates, such that the user may select a predetermined template independently, i.e., the user may independently select the background image and the background music of the video. Therefore, a better personalized effect is achieved for the video.

In some embodiments, the first predetermined operation is a predetermined record operation, and acquiring the target audio based on the first predetermined operation includes: acquiring target audio by recording audio input by the user based on the predetermined record operation. That is, in a case that the first target operation is a record operation, the terminal records the target audio in response to the record operation.

In some embodiments, the predetermined record operation may be exhibited in a plurality of forms, and the following examples are used for explanation.

In one example, in a case that an action object of the predetermined record operation is any position in the video editing interface, the predetermined record operation may be a touch operation, such as a tap operation, a swipe operation, or a long-press operation, performed on any position of the video editing interface.

In another example, in a case that the video editing surface displays a record control, and the action object of the predetermined record operation is the record control, the predetermined record operation may include a one-time touch operation for the record control, or may include successively twice touch operations for the record control. In some embodiments, in a case that the predetermined record operation includes a one-time touch operation for the record control, in response to the touch operation being performed by the user to the record control, the terminal starts to record audio input by the user and automatically stops recording in a case that the duration of the recording is equal to a predetermined duration; and in a case that the predetermined record operation includes successively twice touch operations for the record control, in response to the first touch operation being performed by the user to the record control, the terminal starts to record audio input by the user, and in response to the second touch operation being performed by the user to the record control, the terminal stops recording the audio input by the user.

In some embodiments, the audio input by the user is any sound made by the user, for example, a paragraph (e.g., a blessing) spoken by the user, a poem read by the user, or a tune hummed by the user or a song sung by the user, which is not specifically limited in the embodiments of the present disclosure.

In a case that the first predetermined operation is the predetermined record operation, the target audio may be acquired by recording audio input by the user in response to the predetermined record operation. Therefore, the user may be enabled to directly record his/her own voice and integrate his/her own voice into the target video. In this way, not only may the speed of acquiring the target audio be increased, but also a better personalized effect is achieved for the video, and the operation is convenient.

In some embodiments, the video editing interface further displays recommendation information, the recommendation information being configured to recommend recorded content to the user.

In some embodiments, the recommendation information may include at least one of a prompt and the recorded content. The prompt herein may be used to prompt the user about a type of the recorded content, and the recorded content may be the content recommended to the user for recording. To facilitate understanding, the following example is used for explanation. For example, the prompt is rad a poem, while the corresponding recorded content is the text content of the poem; or the prompt is sing a song, while the corresponding recorded content is lyrics of the song. In this way, the user may directly read or sing to perform recording of voice.

In a case that the first predetermined operation is the predetermined record operation, the video editing interface further displays the recommendation information, wherein the recommendation information is configured to recommend the recorded content to the user, and thus the user may get prompts of recording inspiration before recording. In this way, in a case that the user does not know what audio to record, or what audio is better to record, the user may acquire a recording inspiration quickly from the recommendation information, thereby improving the recording efficiency.

In some embodiments, in response to S11, the method further includes: switching the displayed recommendation information based on an eleventh predetermined operation of the user for the video editing interface, wherein the switched recommendation information is different from the recommendation information that is not switched. That is, the terminal switches the displayed recommendation information in response to a switch operation for the recommendation information in the video editing interface, wherein the switched recommendation information is different from the recommendation information that is not switched.

In some embodiments, in a case that the user is not satisfied with the recommendation information displayed in the video editing interface, the user can switch the recommendation information by performing the eleventh predetermined operation for the video editing interface.

In some embodiments, the eleventh predetermined operation includes, but is not limited to, various touch operations such as a tap operation (e.g., a single-tap operation or a double-tap operation), a swipe operation, or a long-press operation. In some embodiments, an action object of the eleventh predetermined operation is any position in the video editing interface, or in response to the video editing interface displaying a recommendation switch control, the action object of the eleventh predetermined operation is the recommendation switch control.

In some embodiments, the switched recommendation information and the recommendation information that is not switched may be used to recommend different recorded contents to the user. To facilitate understanding, the following examples are used for explanation. For example, prior to switching, the recommendation information displayed in the video editing interface is: Send a blessing—Goodhealth: All wishes come true; while in response to the switching, the recommendation information displayed in the video editing interface is: Read an ancient poem—Wild grasses spread over ancient plain: With spring and fall they come and go. Wildfire can't burn them up again: They rise when vernal breezes blow.

The displayed recommendation information may be switched based on the eleventh predetermined operation of the user for the video editing interface, wherein the switched recommendation information is different from the recommendation information that is not switched, and thus the user may be enabled to view different recommendation information. Therefore, the human-machine interaction efficiency is improved.

In some embodiments, in response to S12 and prior to S13, the method further includes: acquiring target character information by performing character conversion on the target audio.

S13 includes: generating a target video based on the target character information, the target audio, the background image, and the background music. That is, the terminal acquires the target character information by converting the target audio, and acquires the target video based on the target character information, the target audio, the background image, and the background music.

In some embodiments, the character information may also be called subtitles. The target video, generated based on the target character information, the target audio, the background image, and the background music, may include the target audio, the target character information, the background image, and the background music. In this way, in response to the user opening the target video, the background image and the target character information may be displayed, and the background music and the target audio may be played at the same time.

In some embodiments, a character display effect of the target character information may be a target character display effect. The character display effect herein includes at least one of the followings: font, font color, font size, font weight and dynamic display effect. In some embodiments, the target character display effect corresponds to the video editing interface. In a case that the character display effect of the target character information is the target character display effect and the target character display effect corresponds to the video editing interface, the target video is enabled to display the target character information with the target character display effect. In this way, a better personalized effect is achieved for the video.

The target character information is acquired by converting the target audio, and the target video is acquired based on the target character information, the target audio, the background image, and the background music. Therefore, the audio input by the user may be automatically converted into characters and a video is thus generated based on the audio input by the user and the characters converted from the audio. In this way, the target video may display the target audio and the character information corresponding to the target audio at the same time.

In some embodiments, in response to S12 and prior to S13, the method further includes: acquiring target character information by character conversion for the target audio; and displaying the target character information and editing the target character information based on a second predetermined operation of the user for the target character information, wherein the second predetermined operation is a second target operation.

S13 includes: generating a target video based on the edited target character information, the target audio, the background image, and the background music.

Specifically, the terminal displays the target character information, acquires the edited target character information in response to the second target operation for the target character information, and acquires the target video based on the edited target character information, the target audio, the background image, and the background music.

In some embodiments, the second predetermined operation includes, but is not limited to, various touch operations such as a tap operation (a single-tap operation or a double-tap operation), a swipe operation, or a long-press operation. The editing operation may be understood as a modifying operation.

In some embodiments, the target video, generated based on the edited target character information, the target audio, the background image, and the background music, includes the edited target character information, the target audio, the background image, and the background music. In this way, in response to the user opening the target video, the background image and the edited target character information may be displayed and the background music and the target audio may be played at the same time.

The target character information acquired by character conversion for the target audio is displayed, the target character information is edited based on the second predetermined operation of the user for the target character information, and the target video is generated based on the edited target character information, the target audio, the background image, and the background music. Therefore, the user may be enabled to modify the character information independently. In this way, in a case that the user expects that the character information displayed in the target video is different from the content played in the target audio, the user acquires the actually required character information by editing the target character information, such that a better personalized effect is achieved for the video.

In some embodiments, the first predetermined operation is a predetermined character input operation, and acquiring the target audio based on the predetermined operation includes: acquiring first character information input by the user based on the predetermined character input operation; and converting the first character information into the target audio. The first character information also refers to the target character information. That is, in a case that the first target operation is a character input operation, the terminal acquires the input target character information in response to the character input operation, and converts the target character information into the target audio.

In some embodiments, the predetermined character input operation may be exhibited in a plurality of forms, and the following examples are used for explanation.

For Example, in a case that an action object of the predetermined character input operation is any position in the video editing interface, the predetermined character input operation is an operation of handwriting character information in any position of the video editing interface.

In another example, in a case that the video editing interface displays a text input box, and the action object of the predetermined character input operation is the text input box, the predetermined character input operation is an operation of inputting character information in the text input box.

In some embodiments, the first character information, i.e., the target character information, may include words, symbols, punctuation, numbers, emoticons, or the like. For example, the first character information, i.e., the target character information, is: Xiaoming, Happy Birthday To You, or Doing good deeds without asking for reward; Let us work hard together.

In a case that the first predetermined operation is the predetermined character input operation, the first character information input by the user is acquired based on the predetermined character input operation, and the first character information is converted into the target audio. Therefore, the user may be enabled to input, in the form of characters, the content the user wants to express, and integrate, in the form of audio, the input content that the user wants to express into the target video. In this way, a better personalized effect is achieved for the video, and various application scenarios are also better adapted, such as scenarios where it is inconvenient for users to directly record audio.

In some embodiments, S13 includes: generating a target video based on the first character information, the target audio, the background image, and the background music. That is, the terminal generates the target video based on the first character information, i.e., the target character information, the target audio, the background image, and the background music.

In some embodiments, the character information may also be called subtitles. The target video, generated based on the first character information, the target audio, the background image, and the background music, may include the target audio, the first character information, the background image, and the background music. In this way, in response to the user opening the target video, the background image and the first character information may be displayed and the background music and the target audio may be played at the same time.

In some embodiments, a character display effect of the first character information is a target character display effect. The character display effect herein may include at least one of the followings: font, font color, font size, font weight and dynamic display effect. In some embodiments, a first character display effect corresponds to the video editing interface. In a case that the character display effect of the first character information is the target character display effect and the target character display effect corresponds to the video editing interface, the target video is enabled to display the first character information with the target character display effect. In this way, a better personalized effect is achieved for the video.

The target video may be generated based on the first character information, the target audio, the background image, and the background music. Therefore, the character information input by the user may be automatically converted into audio, and a video may be generated based on the character information input by the user and the audio acquired by converting the character information. In this way, the target video may display the character information corresponding to the target audio while playing the target audio.

In some embodiments, in response to S12 and prior to S13, the method further includes: displaying the first character information, and editing the first character information based on a third predetermined operation of the user for the first character information, wherein the first character information also refers to target character information, and the third predetermined operation refers to an editing operation for the first character information, i.e., the target character information.

S13 includes: generating a target video based on the edited first character information, the target audio, the background image, and the background music.

In some embodiments, the third predetermined operation includes, but is not limited to, various touch operations such as a tap operation (a single-tap operation or a double-tap operation), a swipe operation, or a long-press operation. The editing operation may be understood as a modifying operation.

In some embodiments, the target video, generated based on the edited first character information, the target audio, the background image, and the background music, may include the edited first character information, the target audio, the background image, and the background music. In this way, in response to the user opening the target video, the background image and the edited first character information may be displayed and the background music and the target audio may be played at the same time.

The first character information may be displayed and edited based on the third predetermined operation of the user for the first character information, and the target video may be generated based on the edited first character information, the target audio, the background image, and the background music. Therefore, the user may be enabled to modify character information independently. In this way, in a case that the user expects that the character information displayed in the target video is different from the content played in the target audio, the user may acquire the actually required character information by editing the target character information, such that a better personalized effect is achieved for the video.

In some embodiments, prior to S13, the method further includes: receiving a fourth predetermined operation of the user for the video editing interface; and determining a target sound effect corresponding to the fourth predetermined operation, wherein a sound effect of the target audio is the target sound effect. The fourth predetermined operation refers to a selection operation for the target sound effect in the video editing interface. That is, the terminal adds the target sound effect to the target audio in response to the selection operation for the target sound effect in the video editing interface.

In some embodiments, the fourth predetermined operation includes, but is not limited to, various touch operations such as a tap operation (a single-tap operation or a double-tap operation), a swipe operation, or a long-press operation.

In some embodiments, an action object of the fourth predetermined operation may be any position in the video editing interface. In a case that the video editing interface displays a plurality of sound controls and the plurality of sound controls respectively correspond to a plurality of different sound effects, the action object of the fourth predetermined operation may be one of the plurality of sound controls. In a case that the action object of the fourth predetermined operation is one of the plurality of sound controls, a sound effect corresponding to an acted sound control may be the target sound effect. Herein, the plurality of different sound effects include, but are not limited to, Lolita voice, Uncle voice, Host tone, Robot voice, and the like.

In some embodiments, the sound effect of the target audio is the target sound effect, which may be understood as that the sound effect of the target audio heard by the user, in a case that the target audio is played, is the target sound effect.

The fourth predetermined operation of the user for the video editing interface may be detected prior to the target video being generated, and the target sound effect corresponding to the fourth predetermined operation may be determined, wherein the sound effect of the target audio is the target sound effect. Therefore, the user may be enabled to process the sound effect of the target audio independently. In this way, the user may select different sound effects according to video-making requirements, for example, the user may select different sound effects to convey different emotions, such that a better personalized effect is achieved for the video.

In some embodiments, prior to S13, the method further includes: receiving a fifth predetermined operation of the user for the video editing interface; and acquiring a target sticker based on the fifth predetermined operation, wherein the fifth predetermined operation refers to a selection operation for the target sticker in the video editing interface.

S13 includes: generating a target video based on the target sticker, the target audio, the background image, and the background music.

Specifically, the terminal acquires the target sticker in response to the selection operation for the target sticker in the video editing interface, and acquires the target video based on the target sticker, the target audio, the background image, and the background music.

In some embodiments, the fifth predetermined operation includes, but is not limited to, various touch operations such as a tap operation (a single-tap operation or a double-tap operation), a swipe operation, or a long-press operation. In some embodiments, an action object of the fifth predetermined operation is any position in the video editing interface, or the action object is a sticker add control displayed in the video interface.

In some embodiments, the target sticker may be various stickers such as a static sticker, a dynamic sticker, or a music sticker. The music sticker herein refers to an animated special effect of a sticker type that may be automatically rhythmic based on the effect of the music.

The fifth predetermined operation of the user for the video editing interface may be detected prior to the target video being generated, the target sticker may be acquired based on the fifth predetermined operation, and the target video may be generated based on the target sticker, the target audio, the background image, and the background music. Therefore, the user may be enabled to add stickers in the target video, such that a better personalized effect is achieved for the video.

In some embodiments, prior to S13, the method further includes: receiving a sixth predetermined operation of the user for the video editing interface; and replacing the background image based on the sixth predetermined operation, wherein the sixth predetermined operation refers to a replacement operation for the background image.

S13 includes: generating a target video based on the target audio, the replaced background image, and the background music.

That is, the terminal acquires the replaced background image in response to the replacement operation for the background image and acquires the target video based on the target audio, the replaced background image, and the background music.

In some embodiments, the sixth predetermined operation includes, but is not limited to, various touch operations such as a tap operation (a single-tap operation or a double-tap operation), a swipe operation, or a long-press operation. In some embodiments, an action object of the sixth predetermined operation is any position in the video editing interface, or, the action object is a function control, e.g., a background image replace control, displayed in the video interface.

In some embodiments, the replaced background image is a predetermined background image, or the replaced background image is a local image uploaded by the user.

The sixth predetermined operation of the user for the video editing interface may be detected prior to the target video being generated, the background image may be replaced based on the sixth predetermined operation, and the target video may be generated based on the target audio, the replaced background image, and the background music. Therefore, the user may be enabled to replace the background image, such that the user may select a favorite background image according to his/her preference, and thus a better personalized effect is achieved for the video.

In some embodiments, prior to S13, the method further includes: receiving a seventh predetermined operation of the user for the video editing interface; and replacing the background music based on the seventh predetermined operation, wherein the seventh predetermined operation refers to a replacement operation for the background music.

Generating the target video based on the target audio, the background image, and background music includes: generating the target video based on the target audio, the background image, and the replaced background music.

Specifically, the terminal acquires the replaced background music in response to the replacement operation for the background music, and acquires the target video based on the target audio, the background image, and the replaced background music.

In some embodiments, the seventh predetermined operation includes, but is not limited to, various touch operations such as a tap operation (a single-tap operation or a double-tap operation), a swipe operation, or a long-press operation. In some embodiments, an action object of the seventh predetermined operation is any position in the video editing interface, or the action object is a background music replace control displayed in the video interface.

In some embodiments, the replaced background music is predetermined background music, or local music uploaded by the user.

The seventh predetermined operation of the user for the video editing interface may be detected prior to the target video being generated, the background music may be replaced based on the seventh predetermined operation, and the target video may be generated based on the target audio, the replaced background music, and the background music. Therefore, the user may be enabled to replace the background music, such that the user may select the favorite background music according to his/her preference, and thus a better personalized effect is achieved for the video.

In some embodiments, in response to S13, the method further includes: receiving an eighth predetermined operation of the user for the video editing interface: and exporting the target video to a target storage location in response to the eighth predetermined operation, wherein the eighth predetermined operation refers to an export operation for the target video. That is, the terminal stores the target video at the target storage location in response to the export operation for the target video.

In some embodiments, the eighth predetermined operation includes, but is not limited to, various touch operations such as a tap operation (a single-tap operation or a double-tap operation), a swipe operation, or a long-press operation. In some embodiments, an action object of the eighth predetermined operation may be any position in the video editing interface, or the action object is an export control displayed in the video editing interface.

In some embodiments, the target storage location is a predetermined storage location, or a storage location determined based on input of the user.

The eighth predetermined operation of the user for the video editing interface may be detected in response to the target video being generated, and the target video may be exported to a target storage location in response to the eighth predetermined operation. Therefore, the user may be enabled to export the target video to the target storage location simply and conveniently. Thus, the target video may be stored more conveniently.

In some embodiments, in response to S13, the method further includes: receiving a ninth predetermined operation of the user for the video editing interface; and sharing the target video to a target third-party platform in response to the ninth predetermined operation, wherein the ninth predetermined operation refers to a sharing operation for the target video, and the target third-party platform refers to a target application. That is, the terminal shares the target video to the target application in response to the sharing operation for the target video.

In some embodiments, the ninth predetermined operation includes, but is not limited to, various touch operations such as a tap operation (a single-tap operation or a double-tap operation), a swipe operation, or a long-press operation. In some embodiments, an action object of the ninth predetermined operation is any position in the video editing interface, or the action object is a share control displayed in the video interface.

In some embodiments, the target third-party platform, i.e., the target application, is bound in advance, or determined according to input of the user. For example, the target third-party platform is an instant messaging platform, a social media platform, or other platforms.

The ninth predetermined operation of the user for the video editing interface may be detected in response to the target video being generated, and the target video is shared to the target third-party platform in response to the ninth predetermined operation. Therefore, the user may be enabled to share the target video to the target third-party platform simply and conveniently, such that the target video may be shared more conveniently.

To facilitate the understanding of the embodiments of the present disclosure, the following example where the user makes the target video by using a smart phone is described for explanation.

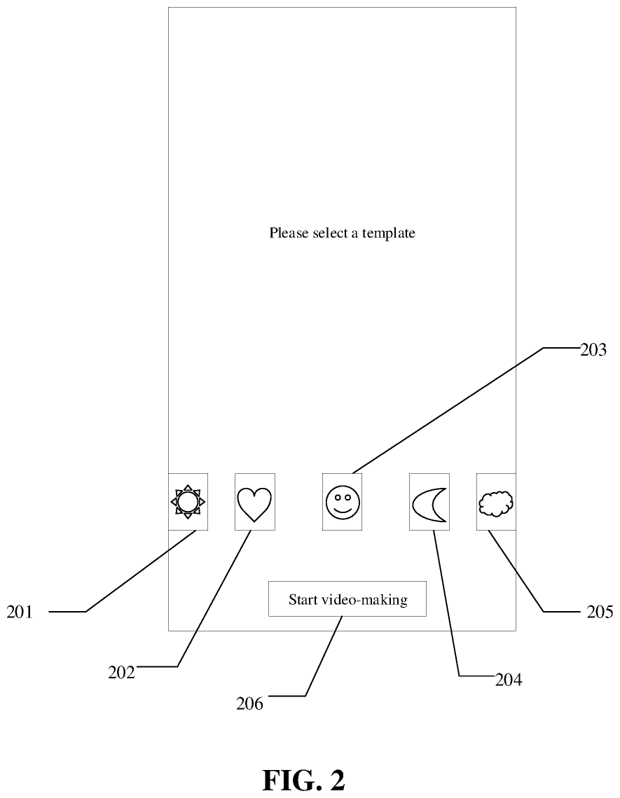

It is assumed that there is an enter control displayed on the desktop of the mobile phone, wherein the enter control is configured to trigger display of a template selection interface, and then, in a case that users need to make a video, users may tap the enter control on the desktop to trigger display of the template selection interface. As shown in FIG. 2, the template selection interface displays five thumbnails 201 to 205 and a video-marking start control 206. The five thumbnails 201 to 205 respectively correspond to five different predetermined templates, and users may preview and select a corresponding predetermined template by tapping the corresponding thumbnail. The video-marking start control 206 is configured to trigger entry into a video editing interface corresponding to the selected predetermined template.

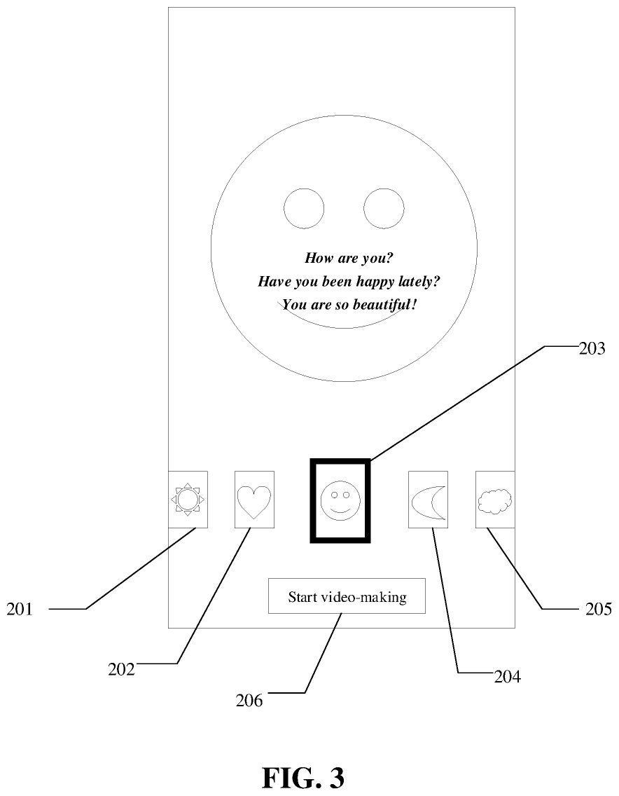

It is assumed that the user taps the thumbnail 203 in the template selection interface as shown in FIG. 2, and then as shown in FIG. 3, the thumbnail 203 is selected, i.e., the thumbnail 203 is enlarged and its border is bold. At the same time, the template selection interface may display a preview effect graph of the predetermined template corresponding to the thumbnail 203 for the user's reference. Next, it is assumed that the user determines to select the predetermined template corresponding to the thumbnail 203 to make a video, the user may tap the video-marking start control 206 to trigger display of the video editing interface corresponding to the predetermined template corresponding to the thumbnail 203.

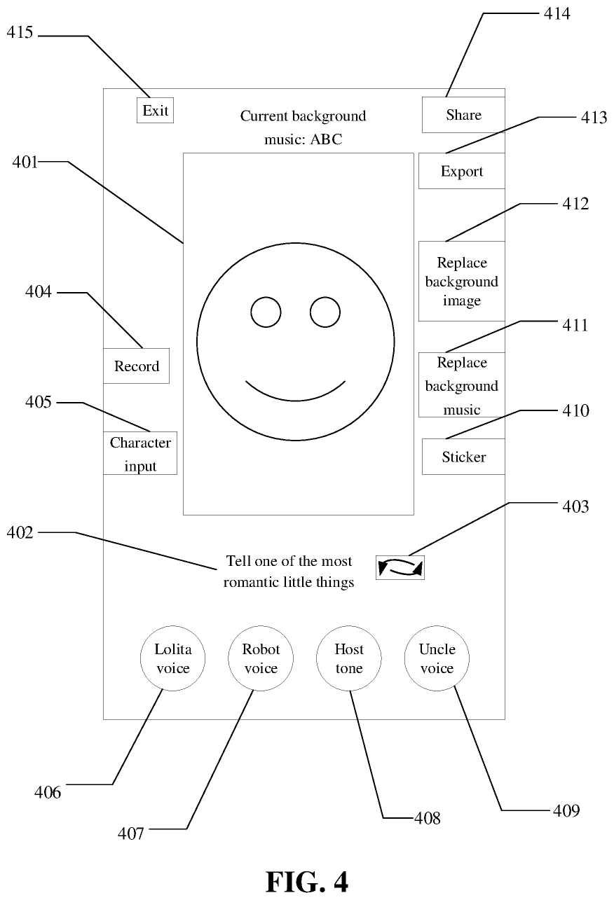

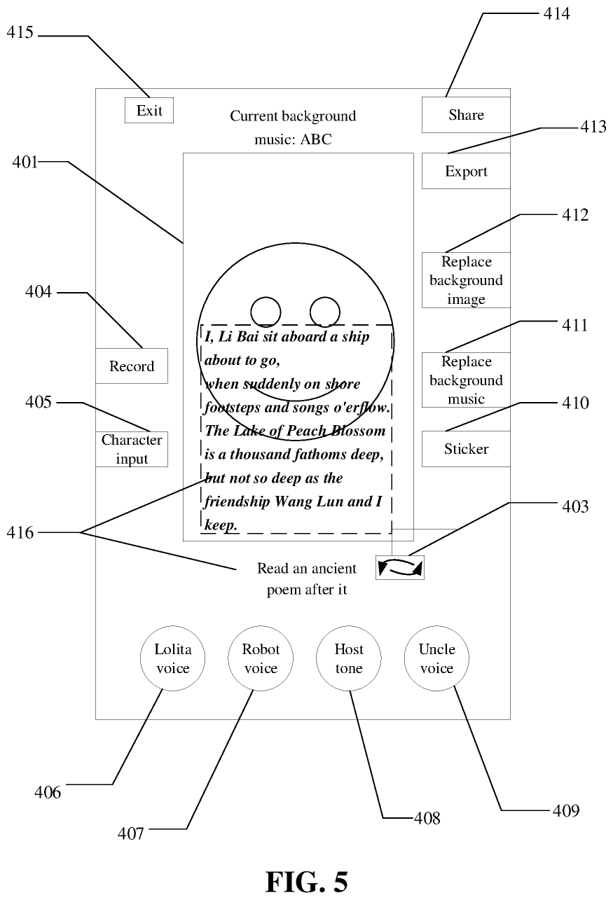

As shown in FIG. 4, the video editing interface corresponding to the predetermined template corresponding to the thumbnail 203 displays a background image 401 (e.g., a first background image), a recommendation information 402 (e.g., a first recommendation information), a recommendation switch control 403, a record control 404, a character input control 405, four sound effect controls 406 to 409, a sticker add control 410, a background music replace control 411, a background image replace control 412, an export control 413, a share control 414, and an exit control 415. On the interface as shown in FIG. 4, the user may tap the record control 404 to start recording, and then, in response to starting recording, the user may tap the record control 404 to stop recording. In a case that the user does not know what to record, the user may acquire inspiration by viewing the recommendation information 402; in a case that the user does not like the content recommended by the first recommendation information 402, the user may replace the first recommendation information by tapping the recommendation switch control 403 at the side of the first recommendation information 402. Upon the tapping, as shown in FIG. 5, the first recommendation information is replaced by the second recommendation information 416. In a case that it is inconvenient for the user to record directly, the user may also call out a text box by tapping the character input control 405, and then input character information in the text box. In response to the character information being input, the mobile phone automatically converts the character information input by the user into audio. In response to the audio being acquired by recording or inputting characters, the sound effect of the audio may be adjusted to a sound effect corresponding to a tapped sound effect control by tapping any one of the four sound effect controls 406 to 409. In addition, the user may add a sticker into the video by tapping the sticker add control 410, replace the background music by tapping the background music replace control 411, and replace the background image by tapping the background image replace control 412. Finally, in response to the design being completed, the user may tap the export control 413 to generate the target video and export the target video to an album; or the user may also tap the share control 414 to generate the target video and share the target video to a third-party platform. In a case that the user decides to give up making the video halfway, the user may directly tap the exit control 415 to exit the video editing interface.

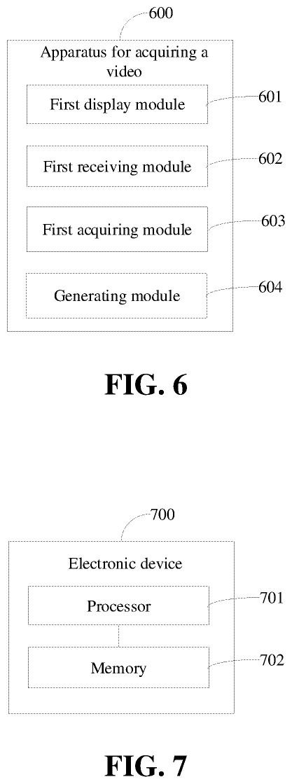

FIG. 6 is a block diagram of an apparatus 600 for acquiring a video according to an embodiment. Referring to FIG. 6, the apparatus 600 includes a first display module 601, a first receiving module 602, a first acquiring module 603, and a generating module 604.

The first display module 601 is configured to display a video editing interface, wherein the video editing interface displays a background image.

The first receiving module 602 is configured to receive a first predetermined operation of a user for the video editing interface during a process of playing background music. That is, the first receiving module 602 is configured to play the background music and detect a first target operation for the video editing interface.

The first acquiring module 603 is configured to acquire target audio based on the first predetermined operation. That is, the first acquiring module 603 is configured to acquire the target audio in response to the first target operation for the video editing interface.

The generating module 604 is configured to generate a target video based on the target audio, the background image, and the background music. That is, the generating module 604 is configured to acquire the target video based on the target audio, the background image, and the background music.

The first predetermined operation of the user for the video editing interface may be detected during the process of playing the background music, the target audio may be acquired based on the first predetermined operation of the user for the video editing interface, and the target video may be generated based on the target audio, the background image displayed in the video editing interface, and the background music. Therefore, the electronic device is enabled to generate the video only by acquiring the target audio based on the first predetermined operation of the user. In this way, the user may make videos meeting individual requirements without shooting objects or persons, such that it is more convenient to generate the video.

In some embodiments, the first predetermined operation is a predetermined record operation, that is, the first target operation is a record operation; and the first acquiring module 603 is configured to acquire the target audio by recording audio input by the user based on the predetermined record operation, that is, the first acquiring module is configured to record the target audio in response to the record operation.

In some embodiments, the video editing interface also displays recommendation information, wherein the recommendation information is configured to recommend recorded content to the user.

In some embodiments, the generating module 604 is configured to acquire the target video based on target character information, the target audio, the background image, and the background music.

In some embodiments, the apparatus 600 further includes: a converting module configured to acquire the target character information by converting the target audio.

In some embodiments, the apparatus 600 further includes: a second display module, configured to display the target character information; and a first editing module, configured to edit the target character information based on a second predetermined operation of the user for the target character information. That is, the first editing module is configured to acquire the edited target character information in response to a second target operation for the target character information.

The generating module 604 is configured to acquire the target video based on the edited target character information, the target audio, the background image, and the background music.

In some embodiments, the first predetermined operation is a predetermined character input operation, i.e., the first target operation is a character input operation. The first acquiring module 603 includes: an acquiring unit configured to acquire first character information input by the user based on the predetermined character input operation, i.e., acquire the input target character information in response to the character input operation: and a converting unit configured to convert the first character information into the target audio, i.e., convert the target character information into the target audio.

In some embodiments, the generating module 604 is configured to generate a target video based on the first character information, the target audio, the background image, and the background music.

In some embodiments, the apparatus 600 further includes: a third display module, configured to display the first character information; and a second editing module, configured to edit the first character information based on a third predetermined operation of the user for the first character information.

The generating module 604 is configured to generate the target video based on the edited first character information, the target audio, the background image, and the background music.

In some embodiments, the apparatus 600 further includes: a second receiving module, configured to receive a fourth predetermined operation of the user for the video editing interface; and a determining module, configured to determine a target sound effect corresponding to the fourth predetermined operation, wherein a sound effect of the target audio is the target sound effect. That is, the determining module is configured to add the target sound effect to the target audio in response to a selection operation for the target sound effect in the video editing interface.

In some embodiments, the apparatus 600 further includes: a third receiving module, configured to receive a fifth predetermined operation of the user for the video editing interface; and a second acquiring module, configured to acquire a target sticker based on the fifth predetermined operation. That is, the second acquiring module is configured to acquire the target sticker in response to a selection operation for the target sticker in the video editing interface.

The generating module 604 is configured to acquire the target video based on the target sticker, the target audio, the background image, and the background music.

In some embodiments, the apparatus 600 further includes: a fourth receiving module, configured to receive a sixth predetermined operation of the user for the video editing interface; and a first replacing module, configured to replace the background image based on the sixth predetermined operation. That is, the first replacing module is configured to acquire the replaced background image in response to a replacement operation for the background image.

The generating module 604 is configured to acquire the target video based on the target audio, the replaced background image, and the background music.

In some embodiments, the apparatus 600 further includes: a fifth receiving module, configured to receive a seventh predetermined operation of the user for the video editing interface; and a second replacing module, configured to replace the background music based on the seventh predetermined operation. That is, the second replacing module is configured to acquire the replaced background music in response to a replacement operation for the background music.

The generating module 604 is configured to acquire the target video based on the target audio, the background image, and the replaced background music.

In some embodiments, the apparatus 600 further includes: a sixth receiving module, configured to receive an eighth predetermined operation of the user for the video editing interface; and an exporting module, configured to export the target video to a target storage location in response to the eighth predetermined operation. That is, the exporting module is configured to store the target video at the target storage location in response to an export operation for the target video.

In some embodiments, the apparatus 600 further includes: a seventh receiving module, configured to receive a ninth predetermined operation of the user for the video editing interface; and a sharing module, configured to share the target video to a target third-party platform in response to the ninth predetermined operation. That is, the sharing module is configured to share the target video to a target application in response to a sharing operation for the target video.

With regard to the apparatus in the above embodiments, the specific operation of each module is described in details in the method-relevant embodiments, which is not repeated herein.

FIG. 7 is a block diagram of an electronic device 700 according to an embodiment. As shown in FIG. 7, the electronic device 700 includes a processor 701 and a memory 702 configured to store one or more instructions executable by the processor 701. The processor 701, when loading and executing the one or more instructions, is caused to perform processes of the method for acquiring the video and achieve the same technical effect, which is not repeated herein.

In some embodiments, the processor 701, when loading and executing the one or more instructions, is further caused to: display a video editing interface, wherein the video editing interface displays a background image; play background music; acquire target audio in response to a first target operation for the video editing interface; and acquire a target video based on the target audio, the background image, and the background music.

In some embodiments, the processor 701, when loading and executing the one or more instructions, is further caused to acquire the target video based on target character information, the target audio, the background image, and the background music.

In some embodiments, the processor 701, when loading and executing the one or more instructions, is further caused to acquire the target character information by converting the target audio.

In some embodiments, the first target operation is a character input operation, and the processor 701, when loading and executing the one or more instructions, is further caused to: acquire the target character information input in response to the character input operation; and convert the target character information into the target audio.

In some embodiments, the processor 701, when loading and executing the one or more instructions, is further caused to: display the target character information; acquire edited target character information in response to a second target operation for the target character information; and acquire the target video based on the edited target character information, the target audio, the background image, and the background music.

In some embodiments, the first target operation is a record operation, and the processor 701, when loading and executing the one or more instructions, is further caused to: record the target audio in response to the record operation.

In some embodiments, the video editing interface further displays recommendation information, wherein the recommendation information is configured to recommend recorded content.

In some embodiments, the processor 701, when loading and executing the one or more instructions, is further caused to add a target sound effect in the video editing interface to the target audio in response to a selection operation for the target sound effect.

In some embodiments, the processor 701, when loading and executing the one or more instructions, is further caused to: acquire a target sticker in the video editing interface in response to a selection operation for the target sticker; and acquire the target video based on the target sticker, the target audio, the background image, and the background music.

In some embodiments, the processor 701, when loading and executing the one or more instructions, is further caused to: acquire a replaced background image in response to a replacement operation for the background image; and acquire the target video based on the target audio, the replaced background image, and the background music.

In some embodiments, the processor 701, when loading and executing the one or more instructions, is further caused to: acquire replaced background music in response to a replacement operation for the background music; and acquire the target video based on the target audio, the background image and the replaced background music.

In some embodiments, the processor 701, when loading and executing the one or more instructions, is further caused to: store the target video at a target storage location in response to an export operation for the target video.

In some embodiments, the processor 701, when loading and executing the one or more instructions, is further caused to: share the target video to a target application in response to a sharing operation for the target video.

In an embodiment of the present disclosure, a storage medium including one or more instructions is also provided. The one or more instructions, when loaded and executed by a processor of an electronic device, cause the electronic device to perform the processes of the method for acquiring the video in the method embodiment corresponding to FIG. 1, and achieve the same technical effect, which is not repeated herein. In some embodiments, the storage medium may be a non-transitory computer-readable storage medium. For example, the non-transitory computer-readable storage medium may be a read-only memory (ROM), a random-access memory (RAM), a compact disc read-only memory (CD-ROM), a magnetic tape, a floppy disk, an optical data storage device, or the like.

In some embodiments, the one or more instructions, when loaded and executed by a processor of an electronic device, cause the electronic device to: display a video editing interface, wherein the video editing interface displays a background image; play background music; acquire target audio in response to a first target operation for the video editing interface; and acquire a target video based on the target audio, the background image, and the background music.

In some embodiments, the one or more instructions, when loaded and executed by a processor of an electronic device, further cause the electronic device to acquire the target video based on target character information, the target audio, the background image, and the background music.

In some embodiments, the one or more instructions, when loaded and executed by a processor of an electronic device, further cause the electronic device to acquire the target character information by converting the target audio.

In some embodiments, the first target operation is a character input operation, and the one or more instructions, when loaded and executed by a processor of an electronic device, further cause the electronic device to: acquire the target character information input in response to the character input operation; and convert the target character information into the target audio.

In some embodiments, the one or more instructions, when loaded and executed by a processor of an electronic device, further cause the electronic device to: display the target character information; acquire edited target character information in response to a second target operation for the target character information; and acquire the target video based on the edited target character information, the target audio, the background image and the background music.

In some embodiments, the first target operation is a record operation, and the one or more instructions, when loaded and executed by a processor of an electronic device, further cause the electronic device to record the target audio in response to the record operation.

In some embodiments, the video editing interface further displays recommendation information, wherein the recommendation information is configured to recommend recorded content.

In some embodiments, the one or more instructions, when loaded and executed by a processor of an electronic device, further cause the electronic device to add a target sound effect in the video editing interface to the target audio in response to a selection operation for the target sound effect.

In some embodiments, the one or more instructions, when loaded and executed by a processor of an electronic device, further cause the electronic device to: acquire a target sticker in the video editing interface in response to a selection operation for the target sticker; and acquire the target video based on the target sticker, the target audio, the background image, and the background music.

In some embodiments, the one or more instructions, when loaded and executed by a processor of an electronic device, further cause the electronic device to: acquire a replaced background image in response to a replacement operation for the background image; and acquire the target video based on the target audio, the replaced background image, and the background music.

In some embodiments, the one or more instructions, when loaded and executed by a processor of an electronic device, further cause the electronic device to: acquire replaced background music in response to a replacement operation for the background music; and acquire the target video based on the target audio, the background image, and the replaced background music.

In some embodiments, the one or more instructions, when loaded and executed by a processor of an electronic device, further cause the electronic device to store the target video at a target storage location in response to an export operation for the target video.

In some embodiments, the one or more instructions, when loaded and executed by a processor of an electronic device, further cause the electronic device to share the target video to a target application in response to a sharing operation for the target video.

In an embodiment of the present disclosure, a computer program product is provided. The computer program product includes one or more executable instructions, wherein the one or more executable instructions, when loaded and executed on a computer, causes the computer to perform the processes of the method for acquiring the video according to the method embodiment corresponding to FIG. 1, and achieve the same technical effect, which is not repeated herein.

Other embodiments of the present disclosure may be apparent to those skilled in the art upon consideration of the specification and practice of the present disclosure. This application is intended to cover any variations, uses, or adaptations of the present disclosure following the general principles thereof and including common knowledge or commonly used technical measures which are not disclosed herein. The specification and embodiments are considered as exemplary only, with a true scope and spirit of the present disclosure is indicated by the following claims.

It should be appreciated that the present disclosure is not limited to the exact construction that has been described above and illustrated in the accompanying drawings, and that various modifications and changes may be made without departing from the scope thereof. The scope of the present disclosure is only limited by the appended claims.

What is claimed is:

1. A method for acquiring a video, comprising:
displaying a video editing interface, wherein the video editing interface displays a background image;
playing background music;
acquiring target audio in response to a first target operation for the video editing interface; and
acquiring a target video based on the target audio, the background image, and the background music.

2. The method according to claim 1, wherein said acquiring the target video based on the target audio, the background image, and the background music comprises:
acquiring the target video based on target character information, the target audio, the background image, and the background music.

3. The method according to claim 2, further comprising: acquiring the target character information by converting the target audio.

4. The method according to claim 2, wherein the first target operation is a character input operation, and said acquiring the target audio in response to the first target operation for the video editing interface comprises:
acquiring a target character information input in response to the character input operation; and
converting the target character information into the target audio.

5. The method according to claim 2, wherein said acquiring the target video based on the target character information, the target audio, the background image, and the background music comprises:
displaying the target character information;
acquiring edited target character information in response to a second target operation for the target character information; and
acquiring the target video based on the edited target character information, the target audio, the background image, and the background music.

6. The method according to claim 1, wherein the first target operation is a record operation, and said acquiring the target audio in response to the first target operation for the video editing interface comprises:
recording the target audio in response to the record operation.

7. The method according to claim 6, wherein the video editing interface further displays recommendation information, the recommendation information being configured to recommend recorded content.

8. The method according to claim 1, further comprising: adding a target sound effect in the video editing interface to the target audio in response to a selection operation for the target sound effect.

9. The method according to claim 1, further comprising: acquiring a target sticker in the video editing interface in response to a selection operation for the target sticker;
wherein said acquiring the target video based on the target audio, the background image, and the background music comprises:
acquiring the target video based on the target sticker, the target audio, the background image, and the background music.

10. The method according to claim 1, further comprising: acquiring a replaced background image in response to a replacement operation for the background image;
wherein said acquiring the target video based on the target audio, the background image, and the background music comprises:
acquiring the target video based on the target audio, the replaced background image, and the background music.

11. The method according to claim 1, further comprising: acquiring replaced background music in response to a replacement operation for the background music; and
wherein said acquiring the target video based on the target audio, the background image, and the background music comprises:
acquiring the target video based on the target audio, the background image, and the replaced background music.

12. The method according to claim 1, further comprising: storing the target video at a target storage location in response to an export operation for the target video.

13. The method according to claim 1, further comprising: sharing the target video to a target application in response to a sharing operation for the target video.

14. An electronic device, comprising:
a processor; and
a memory configured to store one or more instructions executable by the processor;
wherein the processor, when loading and executing the one or more instructions, is caused to:
display a video editing interface, wherein the video editing interface displays a background image;
play background music;
acquire target audio in response to a first target operation for the video editing interface; and
acquire a target video based on the target audio, the background image, and the background music.

15. The electronic device according to claim 14, wherein the processor, when loading and executing the one or more instructions, is further caused to acquire the target video based on target character information, the target audio, the background image, and the background music.

16. The electronic device according to claim 15, wherein the processor, when loading and executing the one or more instructions, is further caused to acquire the target character information by converting the target audio.

17. The electronic device according to claim 15, wherein the first target operation is a character input operation, and the processor, when loading and executing the one or more instructions, is further caused to:
acquire a target character information input in response to the character input operation; and
convert the target character information into the target audio.

18. The electronic device according to claim 15, the processor, when loading and executing the one or more instructions, is further caused to:
display the target character information;
acquire edited target character information in response to a second target operation for the target character information; and
acquire the target video based on the edited target character information, the target audio, the background image, and the background music.

19. The electronic device according to claim 14, wherein the first target operation is a record operation, and the processor, when loading and executing the one or more instructions, is further caused to:
record the target audio in response to the record operation.

20. A non-transitory storage medium storing one or more instructions, wherein the one or more instructions, when loaded and executed by a processor of an electronic device, cause the electronic device to:
display a video editing interface, wherein the video editing interface displays a background image;
play background music;
acquire target audio in response to a first target operation for the video editing interface; and
acquire a target video based on the target audio, the background image, and the background music.
